(19) United States
(12) Patent Application Publication
(10) Pub. No.: US 2026/0080671 A1
(43) Pub. Date: Mar. 19, 2026

(54) MASK-BASED FRAMEWORK DEVICE FOR CONTINUAL LEARNING OF TEMPORAL ACTION SEGMENTATION AND ITS OPERATING METHOD

(71) Applicant: CHUNG ANG UNIVERSITY INDUSTRY ACADEMIC COOPERATION FOUNDATION, Seoul (KR)

(72) Inventors: EUN WOO KIM, Seoul (KR); GYEONG-HYEON KIM, Seoul (KR); HYUN DONG JIN, Seoul (KR)

(21) Appl. No.: 19/332,265

(22) Filed: Sep. 18, 2025

(30) Foreign Application Priority Data
Sep. 19, 2024 (KR) 10-2024-0126760

(51) Int. Cl. G06V 10/82; G06N 3/045; G06N 3/0895; G06N 3/096; G06V 10/77; G06V 10/774

(52) U.S. Cl. CPC G06V 10/82; G06N 3/045; G06N 3/0895; G06N 3/096; G06V 10/7715; G06V 10/774

(57) ABSTRACT

A mask-based framework device for continual learning of temporal action segmentation includes an interface unit configured to perform data input/output and a framework model unit configured to perform temporal action segmentation, in which the framework model unit includes a first framework model trained through a previous task and a second framework model trained through a current task from the first framework model, and each of the first framework model and the second framework model receive image data and output binary action mask information and action class classification information.

### CROSS-REFERENCE TO RELATED APPLICATION AND CLAIM OF PRIORITY

This application claims the benefit under 35 USC § 119 (a) of Korean Patent Application No. 10-2024-0126760, filed on Sep. 19, 2024, in the Korean Intellectual Property Office, the entire disclosure of which is incorporated herein by reference for all purposes.

### BACKGROUND

### 1. Field

The present disclosure relates to a mask-based framework device for continual learning of temporal action segmentation and its operating method.

### 2. Description of Related Art

In continuous learning for temporal action segmentation, a new problem, which is background semantic shift, arises in addition to catastrophic forgetting, which is mainly addressed in existing continual learning techniques. This phenomenon is observed in class-incremental semantic segmentation, and may occur when unlabeled classes unseen in the current task are included in the background. This leads to the accumulation of semantic inconsistencies over time, which can further exacerbate catastrophic forgetting and make it difficult to retain previously learned knowledge.

Furthermore, conventional temporal action segmentation models use a multi-stage architecture that iteratively refines class predictions from previous stages. In such a structure, the performance of the model may degrade because new parameter additions and initialization are needed due to predictions at intermediate stages when learning new classes. In particular, there is a high risk of impairing the performance of previously learned classes in the process of learning new classes.

Conventional temporal action segmentation models predict action segments using a frame-wise classification method, which can easily lead to over-segmentation errors. These errors may lead to fragmentation of predicted action segments, exacerbating the problems of fatal forgetting and background semantic shift during continual learning, thereby degrading the overall performance of the model.

Examples of related art may include Korean Unexamined Patent Application Publication No. 10-2021-0114257.

### SUMMARY

Embodiments of the present disclosure are intended to provide a mask-based framework device for continual learning of temporal action segmentation and its operating method.

According to an aspect of the present disclosure, there is provided a mask-based framework device including an interface unit configured to perform data input/output and a framework model unit configured to perform temporal action segmentation, in which the framework model unit includes a first framework model trained through a previous task and a second framework model trained through a current task from the first framework model, each of the first framework model and the second framework model receives image data and outputs binary action mask information and action class classification information, the binary action mask information is information classified as 0 or 1 depending on whether each frame of the image data is an action class, and the action class classification information is information about an action class learned in the corresponding task.

The second framework model may additionally learn the current task while preserving a knowledge of the first framework model trained in the previous task.

The framework model unit may include a backbone configured to extract a feature of input image data, a frame decoder configured to extract a class-agnostic feature based on the feature of the image data output from the backbone, and a transformer decoder configured to extract an action class feature based on a query containing action class information and an intermediate feature value of the frame decoder.

The query may be a learnable parameter and include a fixed number of action class information.

The framework model unit may be configured to generate binary action mask information based on a class-independent feature generated by the frame decoder and an action class feature output from the transformer decoder.

The framework model unit may be configured to generate action class classification information based on the action class feature output from the transformer decoder.

The framework model unit may be configured to perform knowledge distillation on the action class classification information output from the second framework model based on the action class classification information output from the first framework model to mitigate background semantic shift.

The framework model unit may be configured to generate a pseudo-label that does not exist in the current task based on the action class classification information output through the first framework model.

The pseudo-label may be generated based on a class having the highest probability among classes excluding a non-object class, based on the action class classification information output through the first framework model.

According to another aspect of the present disclosure, there is provided a method performed on a computing device that includes one or more processors and a memory storing one or more programs executed by the one or more processors, the method including receiving input image data and outputting binary action mask information and action class classification information for input image data using a first framework model learned through a previous task and a second framework model learned through a current task from the first framework model that perform temporal action segmentation, in which the binary action mask information is information classified as 0 or 1 depending on whether each frame of the image data is an action class and the action class classification information is information about an action class learned in the corresponding task.

According to still another aspect of the present disclosure, there is provided a computer program stored on a non-transitory computer readable storage medium, the computer program including one or more instructions, the instructions, when executed by a computing device having one or more processors, causing the computing device to perform receiving input image data and outputting binary action mask information and action class classification information for input image data using a first framework model learned through a previous task and a second framework model learned through a current task from the first framework model that perform temporal action segmentation, in which the binary action mask information is information classified as 0 or 1 depending on whether each frame of the image data is an action class and the action class classification information is information about an action class learned in the corresponding task.

### BRIEF DESCRIPTION OF THE DRAWINGS

FIG. 1 is a block diagram of a mask-based framework device according to an embodiment.

FIG. 2 is an exemplary diagram illustrating the configuration of a framework model unit according to an embodiment.

FIG. 3 is an exemplary diagram illustrating continual learning of temporal action segmentation according to an embodiment.

FIG. 4 is an exemplary diagram illustrating the configuration of a framework model according to an embodiment.

FIG. 5 is a flowchart illustrating an operating method of the mask-based framework device according to an embodiment.

FIG. 6 is a block diagram for illustratively describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present disclosure, a first component may be referred to as a second component, and similarly, a second component may also be referred to as a first component.

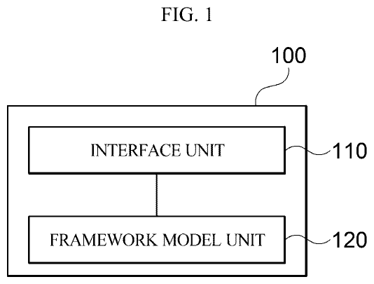

FIG. 1 is a block diagram of a mask-based framework device according to an embodiment.

Referring to FIG. 1, a mask-based framework device 100 may include an interface unit 110 that performs data input/output and a framework model unit 120 that performs temporal action segmentation.

According to an example, the mask-based framework device 100 may be a device that effectively learns a new task while maintaining knowledge of a previous task during continual learning of temporal action segmentation. To this end, the mask-based framework device 100 redefines temporal action segmentation of frame-wise classification into a set prediction method through binary action masks and class classification.

The temporal action segmentation method represents the task of dividing all action segments within the entire video from what point to what point they last.

According to an example, the framework model unit 120 may effectively preserve a knowledge of a previous task through pseudo-labeling and knowledge distillation while learning a new task.

According to an embodiment, the framework model unit 120 may include a first framework model 121 trained through a previous task and a second framework model 125 trained through a current task. For example, the first framework model and second framework model may be trained on different action classes. After training is complete, an inference operation of outputting binary action mask information and action class classification information for the input image data may be performed using the second framework model. That is, the first framework model may be involved only in the learning process of the second framework model.

Specifically, in the learning process, the first framework model 121 that has been trained up to the previous task and the second framework model 125 trained on the current task are used together. This is to learn a new task while preserving the information of the previous task during the learning process. In the inference process, the binary action mask information and action classification information may be output for all tasks learned so far through the second framework model 125 trained for the last task.

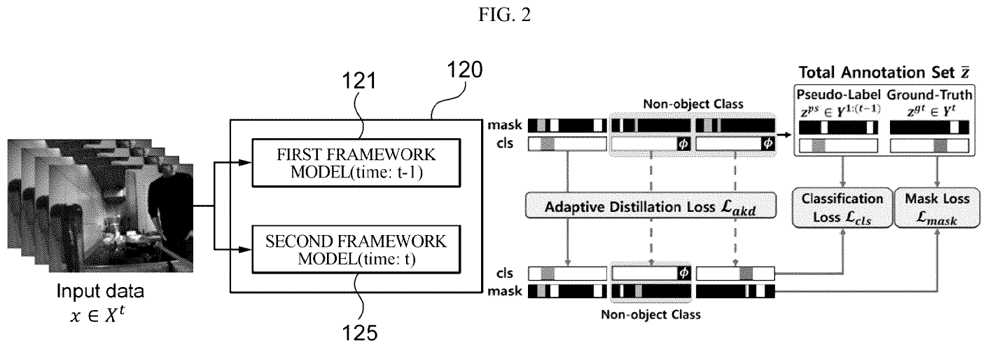

Referring to FIG. 2, the first framework model 121 may be a framework model trained in a previous task t−1, and a second framework model 125 may be a framework model trained in a current task t. In this case, when learning about the current task t, the second framework model 125 may be trained by utilizing the first framework model 121 that has been trained up to the previous task t−1. The second framework model 125 may be identical to the first framework model 121, i.e., the model that has been trained up to the previous task before learning the current task. Tasks may be accumulated and learned in the second framework model 125.

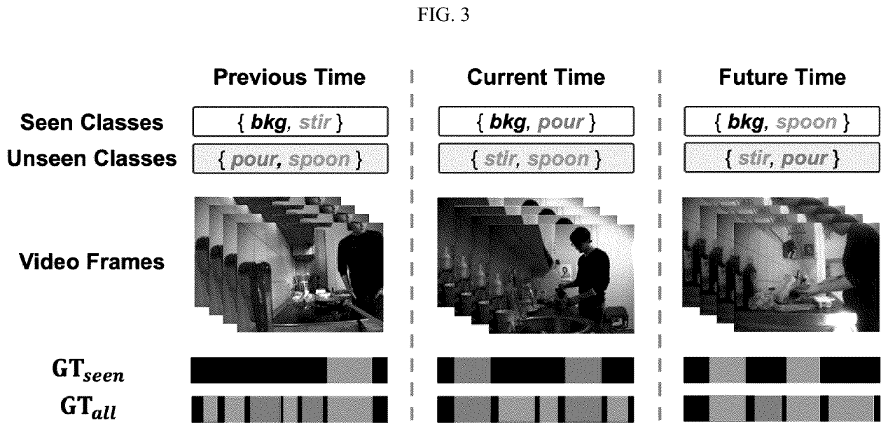

The knowledge of the first framework model trained in the previous task may be preserved by the second framework model learning the current task. In this case, the learned action class may be different for each task. For example, as shown in FIG. 3, learning may be performed on the “stir” action class in the previous task (previous time), and learning may be performed on the “pour” action class in the current task (current time). Furthermore, learning may be performed on the “spoon” action class in the next task (future).

As an example, the framework model may perform continual learning of temporal action segmentation that learns a newly added class K^{t} while preserving the knowledge of a previous class K^{1:(t-1)} for each task (time) (1≤t≤T).

According to an embodiment, each of the first framework model and the second framework model of the framework model unit 120 may receive image data and output binary action mask information and action class classification information, respectively. The first framework model and the second framework model may operate independently. Referring to FIG. 2, each framework model outputs binary action mask information mask and action class classification information cls. Here, the binary action mask information is information classified as 0 or 1 depending on whether each frame is a specific action class. That is, the binary action mask information is information for classifying whether each frame is an action class or a background class that does not contain an action. The action class classification information indicates the action class learned in the corresponding task.

According to an embodiment, the framework model unit 120 may include a backbone that extracts a feature of input image data, a frame decoder that extracts a class-agnostic feature based on the feature of the image data output from the backbone, and a transformer decoder that extracts an action class feature based on a query containing specific action class information and an intermediate feature value of the frame decoder. Here, the query is a learnable parameter and may include a fixed number of action class information. The fixed number of queries may be predetermined, and the query may include each action class information.

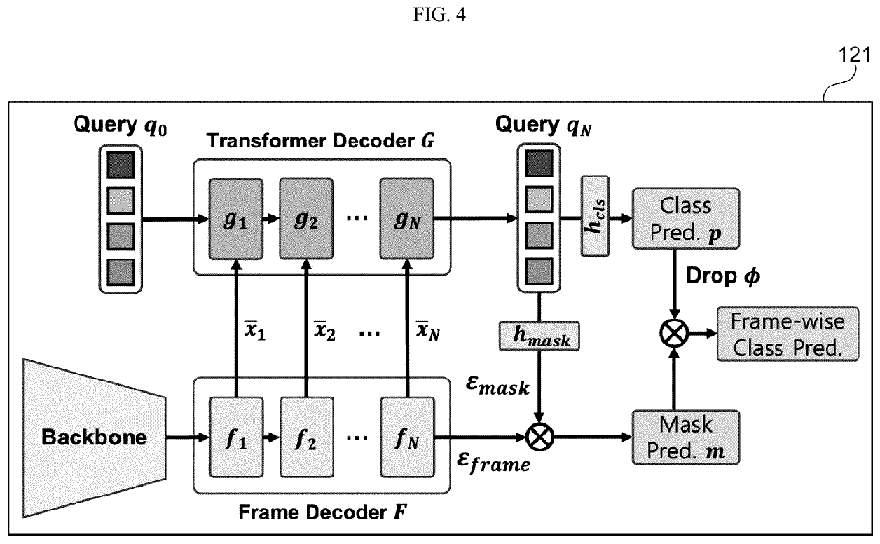

Referring to FIG. 4, the framework model 121 may be composed of a backbone that extracts a video feature, a frame decoder F that extracts a class-agnostic feature from the video feature, and a transformer decoder G that extracts a feature qN for action class prediction based on an intermediate feature extracted from the frame decoder and an action query qₒ.

According to an embodiment, the framework model unit 120 may generate binary action mask information based on a feature unrelated to a specific action class generated by the frame decoder and an action class feature output from the transformer decoder. For example, the binary action mask information Mask pred. m may be expressed as a dot product of a feature value extracted from the frame decoder and εₘₐₛₖ, which is a linear transformation of qN extracted from the transformer decoder.

According to an embodiment, the framework model unit 120 may generate action class classification information based on the action class features output from the transformer decoder. For example, the action class classification information Class pred. p may be expressed as a linear transformation of qN.

According to an example, the final prediction of temporal action segmentation Frame-wise class pred. may be computed through a dot product of the binary action Mask pred. m and an action class classification value p excluding a non-object class φ of the set prediction. To this end, an optimal bipartite matching σ* between a correct label value z^{gt}=(cᵢ^{gt}, mᵢ^{gt})ᵢ=1, . . . , S^{gt} and a predicted value z of the framework is required. Here, σ* may be expressed as Equation 1 below.

$$σ *= arg {min}_{σ ∈ {ψ}_{N}} {\sum }_{i = 1}^{s} {ℒ}_{seg}^{i} ( σ ) , \qquad [ Equation 1 ]$$

$$where {ℒ}_{seg}^{i} ( σ ) = {λ}_{cls} {ℒ}_{cls} ( {p}_{σ ( i )} , {c}_{i}^{gt} ) + {ℒ}_{mask} ( {m}_{σ ( i )} , {m}_{i}^{gt} )$$

Here, cᵢ^{gt} and mᵢ^{gt} represent the i-th correct answer class and binary mask, respectively, and ψₙ represents all possible combinations of bipartite matching. σ(i) represents the index of the model prediction value z that matches the i-th correct answer. L_{cls} represents the classification loss for class prediction, and Lₘₐₛₖ represents the weighted sum of the focal loss and dice loss for binary mask learning.

According to an example, if a loss function may be applied to the intermediate output at all stages for training a mask-based framework of set prediction method, the loss function may be expressed as Equation 2 below.

$${ℒ}_{seg} = {\sum }_{i = 1}^{s} {ℒ}_{seg}^{i} ( σ \text{*)} \qquad [ Equation 2 ]$$

According to an embodiment, the framework model unit 120 may perform knowledge distillation on the action class classification information output from the second framework model based on the action class classification information output through the first framework model to mitigate background semantic shift.

According to an example, the framework model unit 120 may reassign the prediction of the current class K^{t} to the background class by considering the previous task time point as in Equation 3 below in order to perform knowledge distillation while mitigating the background semantic shift, which is an obstacle caused by the presence of a background class.

$${\tilde{p}}_{i} ( j ) = \{ \begin{matrix}{\sum }_{c ∈ {𝒦}^{i}} {p}_{i} ( c ) + {p}_{i} ( b ) & if j = b , \\ {p}_{i} ( j ) & otherwise .\end{matrix} \qquad [ Equation 3 ]$$

According to an example, in direct set prediction method, a distillation weight may be adaptively applied to each prediction to prevent unnecessary distillation of a non-object class not used in actual predictions. The distillation weight, wᵢ may be expressed as Equation 4 below.

$${ω}_{i} = {( 1 - {p}_{i}^{o} ( ϕ ) )}^{2} \qquad [ Equation 4 ]$$

Through the above weight, if the prediction is more likely to be the non-object class, the distillation weight decreases to reduce the distillation effect and adaptively prevent unnecessary distillation. Thus, when performing continual learning on a new class, as shown in FIG. 2, the Lseg of the mask-based framework and z obtained through pseudo-labeling may be used and the knowledge of the new task may be learned while preserving the knowledge of the previous task through adaptive knowledge distillation.

According to an embodiment, the framework model unit 120 may generate pseudo-labels that do not exist in the current task based on the action class classification information output through the first framework model. For example, the framework model unit 120 may generate pseudo-labels for action classes of a previous task that do not exist in the current task based on the prediction results of the previous task learning model.

According to an embodiment, the pseudo-labels may be generated based on the class having the highest probability among the classes excluding the non-object classes, based on the action class classification information output through the first framework model. Pseudo-labels may consist of the action class of the previous task and used in the learning process along with a label of the action class of the current task.

According to an example, the class label

$${c}_{i}^{ps} = arg {max}_{c ∈ {k}^{t - 1}} {p}_{i}^{o} ( c )$$

of the pseudo-label may be determined as the class having the highest probability among the classes excluding the non-object class φ. The binary mask pseudo-label mᵢ^{ps} is defined as a mask that (i) should not label the same location as the label of the current task and (ii) has a confidence of

$${d}_{i} = {p}_{i}^{max} \cdot {m}_{i}^{o}$$

greater than 0.5. Here,

$${p}_{i}^{max} = {max}_{c ∈ {k}^{t - 1}} {p}_{i}^{o} ( c )$$

represents the maximum value among the class prediction values of the previous model,

$${m}_{i}^{o}$$

represents the i-th binary mask prediction value of the previous model.

As an example, the framework model unit 120 may perform training of the framework model with a new label z⁻ that uses the label z^{PS} obtained through pseudo-labeling and the correct answer label of the current task together.

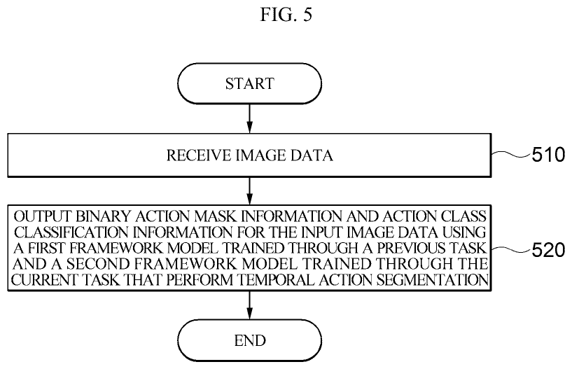

FIG. 5 is a flowchart illustrating an operating method of a mask-based framework device according to an embodiment.

According to an embodiment, the mask-based framework device may be a computing device including one or more processors and a memory storing one or more programs executed by the one or more processors.

According to an embodiment, the mask-based framework device may receive image data (510), and output binary action mask information and action class classification information for the input image data using a first framework model trained through a previous task and a second framework model trained through the current task that perform temporal action segmentation (520). After training is complete, an inference operation of outputting binary action mask information and action class classification information for the input image data may be performed using the second framework model. That is, the first framework model may be involved only in the learning process of the second framework model.

In FIG. 5, embodiments overlapping with the contents described with reference to FIGS. 1 to 4 are omitted

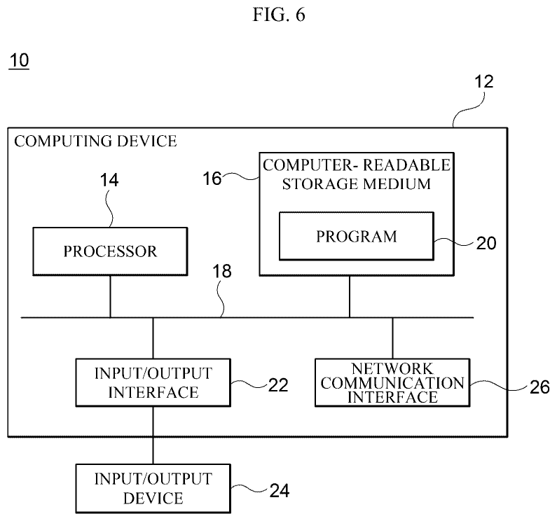

FIG. 6 is a block diagram illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be a mask-based framework device.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to an embodiment, knowledge of the previous task can be preserved through pseudo-labeling, and knowledge distillation can be adaptively performed according to the importance of the class prediction results to effectively maintain previous knowledge.

In addition, through the redefined mask-based framework model, the overall performance of the model can be improved by reducing over-excessive errors that occur during continual learning.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. A mask-based framework device comprising:
an interface unit configured to perform data input/output; and
a framework model unit configured to perform temporal action segmentation;
wherein the framework model unit includes a first framework model trained through a previous task and a second framework model trained through a current task from the first framework model,
each of the first framework model and the second framework model is configured to receive image data and output binary action mask information and action class classification information,
the binary action mask information is information classified as 0 or 1 depending on whether each frame of the image data is an action class, and
the action class classification information is information about an action class learned in the corresponding task.

2. The mask-based framework device of claim 1, wherein the second framework model is configured to additionally learn the current task while preserving a knowledge of the first framework model trained in the previous task.

3. The mask-based framework device of claim 1, wherein the framework model unit includes:
a backbone configured to extract a feature of input image data;
a frame decoder configured to extract a class-agnostic feature based on the feature of the image data output from the backbone; and
a transformer decoder configured to extract an action class feature based on a query containing action class information and an intermediate feature value of the frame decoder.

4. The mask-based framework device of claim 3, wherein the query is a learnable parameter and include a fixed number of action class information.

5. The mask-based framework device of claim 3, wherein the framework model unit is configured to generate binary action mask information based on a class-independent feature generated by the frame decoder and an action class feature output from the transformer decoder.

6. The mask-based framework device of claim 3, wherein the framework model unit is configured to generate action class classification information based on the action class feature output from the transformer decoder.

7. The mask-based framework device of claim 1, wherein the framework model unit is configured to perform knowledge distillation on the action class classification information output from the second framework model based on the action class classification information output from the first framework model to mitigate background semantic shift.

8. The mask-based framework device of claim 1, wherein the framework model unit is configured to generate a pseudo-label that does not exist in the current task based on the action class classification information output through the first framework model.

9. The mask-based framework device of claim 8, wherein the pseudo-label is generated based on a class having the highest probability among classes excluding a non-object class, based on the action class classification information output through the first framework model.

10. A method performed on a computing device comprising one or more processors and a memory storing one or more programs executed by the one or more processors, the method comprising:
receiving input image data; and
outputting binary action mask information and action class classification information for input image data using a first framework model learned through a previous task and a second framework model learned through a current task from the first framework model that perform temporal action segmentation,
wherein the binary action mask information is information classified as 0 or 1 depending on whether each frame of the image data is an action class, and
the action class classification information is information about an action class learned in the corresponding task.

11. A computer program stored on a non-transitory computer readable storage medium, the computer program including one or more instructions, the instructions, when executed by a computing device having one or more processors, causing the computing device to perform:
receiving input image data; and
outputting binary action mask information and action class classification information for input image data using a first framework model learned through a previous task and a second framework model learned through a current task from the first framework model that perform temporal action segmentation,
wherein the binary action mask information is information classified as 0 or 1 depending on whether each frame of the image data is an action class, and
the action class classification information is information about an action class learned in the corresponding task.
